(19) United States
(12) Patent Application Publication
(10) Pub. No.: US 2015/0067285 A1
(43) Pub. Date: Mar. 5, 2015

(54) STORAGE CONTROL APPARATUS, CONTROL METHOD, AND COMPUTER-READABLE STORAGE MEDIUM

(71) Applicant: FUJITSU LIMITED, Kawasaki-shi (JP)

(72) Inventor: Meiu Naruse, Yokohama (JP)

(21) Appl. No.: 14/461,465

(22) Filed: Aug. 18, 2014

(30) Foreign Application Priority Data
Sep. 5, 2013 (JP) 2013-184404

(51) Int. Cl. G06F 3/06

(52) U.S. Cl. CPC G06F 3/0619; G06F 3/065; G06F 3/067; G06F 2201/84
USPC 711/162

(57) ABSTRACT

A movement processing unit retains data in a source area when 10% or more space is available at a source hierarchical level. A read processing unit reads, when data for which a read request is received is present on more than one hierarchical level, the data from a hierarchical level with a low load. A write processing unit records an update state in a bitmap table without updating a copy when a load is high, and updates copied data under the condition that a low-load state continues 10 minutes or longer.

### CROSS-REFERENCE TO RELATED APPLICATION(S)

This application is based upon and claims the benefit of priority of the prior Japanese Patent Application No. 2013-184404, filed on Sep. 5, 2013, the entire contents of which are incorporated herein by reference.

### FIELD

The embodiment discussed herein is related to a storage control apparatus, a control method, and a computer-readable storage medium.

### BACKGROUND

In recent years, automated storage tiering has been practiced for storage systems. The automated storage tiering is a function in which data access to a storage is monitored, an access frequency of data is detected in an environment with different types of drives mixed, and rearrangement of data is automatically performed among drives according to a configured policy.

For example, data with a low use frequency is arranged on a low level in the hierarchy having a low-cost high-capacity hard disk drive (HDD) as a storage device, and thus, the storage system can reduce the storage cost. Moreover, data with a high access frequency is arranged on a high hierarchical level having a high-performance solid state drive (SSD) as a storage device, and thus the storage system can reduce the response time and improve the performance.

Furthermore, there is a conventional technique in which in a storage device having multiple volumes, a file is divided in block units, an identical block is written in the multiple volumes, and different blocks are read from the multiple volumes in parallel (for example, Japanese Laid-open Patent Publication No. 2005-148854).

Moreover, there is a conventional technique in which data is written in a low-speed volume and a high-speed volume, and the data is deleted from the high-speed volume when a predetermined storage period has passed (for example, Japanese Laid-open Patent Publication No. 2006-139552). Furthermore, there is a conventional technique in which data is written in a storage constituted of a low-speed storage device and a storage constituted of a high-speed storage device, and data with decreased access frequency is deleted from the storage constituted of a high-speed storage device (for example, Japanese Laid-open Patent Publication No. 2011-242862).

In the automated storage tiering, a storage control apparatus monitors a range of a predetermined size (for example, approximately 1.34 gigabytes) for a predetermined time period (for example, four hours), and rearrangement (movement to another hierarchical level) of data is performed according to determination based on a threshold in input/output per second (IOPS). Moreover, the storage control apparatus initializes data in a source area after moving to the other hierarchical level.

However, there has been problem that when data is moved to the original hierarchical level after moving to another hierarchical level, that is, the data is moved back, because of a change in the access status, the hierarchical control deteriorates the system performance.

Specifically, if data is moved back, the processing of moving among hierarchical levels and the processing of initializing the data that have been performed previously turn into unnecessary processing. Furthermore, after moving among hierarchical levels by rearrangement, the storage control apparatus performs rearrangement only after monitoring is performed for a predetermined period of time. Therefore, for example, even when the access load increases for the data that has been moved to a lower hierarchal level, rearrangement is performed only after a predetermined period of time passes, and accordingly, only the performance of a low hierarchical level can be obtained.

### SUMMARY

According to an aspect of an embodiment, a storage control apparatus that has an automated storage tiering function includes a determining unit that determines whether it is necessary to move data among hierarchical levels; and a moving unit that controls copy of the data to a destination, and that controls retention of the data at a source based on an available space at the source, when the determining unit determines that it is necessary to move the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of automated storage tiering performed by a storage control apparatus according to an embodiment;

FIG. 2 is a configuration diagram illustrating a hardware configuration of a storage system according to the embodiment;

FIG. 3 illustrates a functional configuration of a controller module (CM);

FIG. 4 illustrates an image of a bitmap table;

FIG. 5 illustrates an example of an arrangement table;

FIG. 6 is a flowchart indicating a flow of a hierarchy moving processing performed by a movement processing unit;

FIG. 7 is a flowchart indicating a flow of a read processing performed by a read processing unit; and

FIG. 8 is a flowchart indicating a flow of a write processing performed by a write processing unit.

### DESCRIPTION OF EMBODIMENT(S)

Preferred embodiments of the present invention will be explained with reference to accompanying drawings. The disclosed technique is not limited to this embodiment.

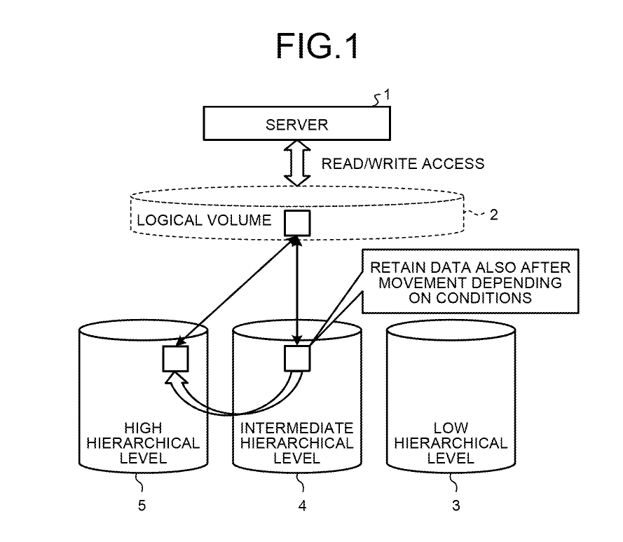

First, automated storage tiering performed by the storage control apparatus according to the embodiment is explained. FIG. 1 is an explanatory diagram of the automated storage tiering performed by the storage control apparatus according to the embodiment. As illustrated in FIG. 1, a server 1 performs a read/write access to a logical volume 2.

Data in the logical volume 2 is stored on a low hierarchical level 3, an intermediate hierarchical level 4, or a high hierarchical level 5 based on IOPS. The low hierarchical level 3 is a near-line disk drive, and the intermediate hierarchical level 4 is an online disk drive, and the high hierarchical level 5 is an SSD. Moreover, each hierarchical level has a redundant arrays of inexpensive disks (RAID) group. In the following, a storage device is called “disk” including SSD.

For example, when data is moved from the intermediate hierarchical level 4 to the high hierarchical level 5, the storage control apparatus according to the embodiment retains the data on the intermediate hierarchical level 4 without performing initialization depending on an available space on the intermediate hierarchical level 4.

Accordingly, when IOPS of the data moved to the high hierarchical level 5 decreases and the data is moved back to the intermediate hierarchical level 4, the storage control apparatus according to the embodiment can use the retained data if the data has not been changed. Therefore, the storage control apparatus according to the embodiment is not required to perform unnecessary data initialization processing and data movement processing, and deterioration of the system performance caused by performing unnecessary processing can be suppressed.

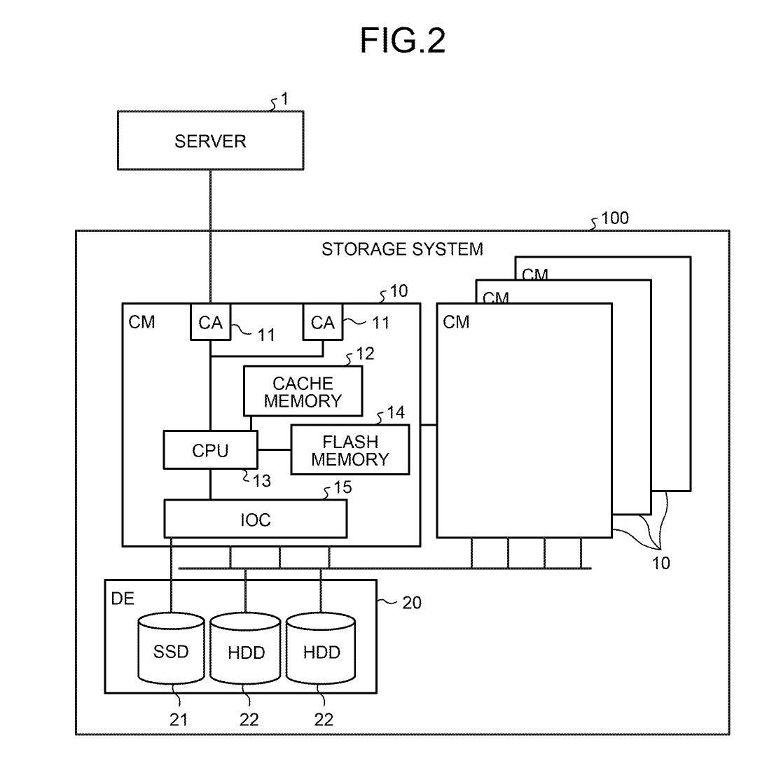

Next, a hardware configuration of the storage system according to the embodiment is explained. FIG. 2 is a configuration diagram illustrating a hardware configuration of the storage system according to the embodiment. As illustrated in FIG. 2, a storage system 100 includes four units of CMs 10 and a drive enclosure (DE) 20. Although in this example, for the convenience sake, a single unit of the DE 20 is illustrated, the storage system 100 may have more than one unit of the DE 20.

The CM 10 is a device that controls the storage system 100 according to a request from the server 1. The DE 20 is a system that is equipped with an SSD 21 and two units of HDDs 22, and provides storage areas of the low hierarchical level 3, the intermediate hierarchical level 4, and the high hierarchical level 5. The SSD 21 provides a storage area of the high hierarchical level 5, and the two units of the HDDs 22 provide storage areas on the intermediate hierarchical level 4 and the low hierarchical level 3, respectively. Although in this example, for the convenience sake, a single unit of the SSD 21 and two units of the HDDs 22 are illustrated, the DE 20 may have an arbitrary number of the SSD 21 and the HDD 22.

The CM 10 includes two units of channel adapters (CA) 11, a cache memory 12, a central processing unit (CPU) 13, a flash memory 14, and an input output controller (IOC) 15.

The CA 11 is a module to connect to the server 1. The cache memory 12 is a memory that temporarily stores data that is read and written by the storage system 100, and also stores data to control the system.

The CPU 13 is a central processing unit that makes the CM 10 function as a control device by executing a program stored in the flash memory 14. The flash memory 14 is a nonvolatile memory that stores a program to be executed by the CPU 13.

The IOC 15 controls write of data to the SSD 21 and the HDDs 22, and read of data from the SSD 21 and the HDDs 22. When a large number of the DEs 20 are connected to the CM 10, the CM 10 is connected to the DE 20 through an expander instead of the IOC 15.

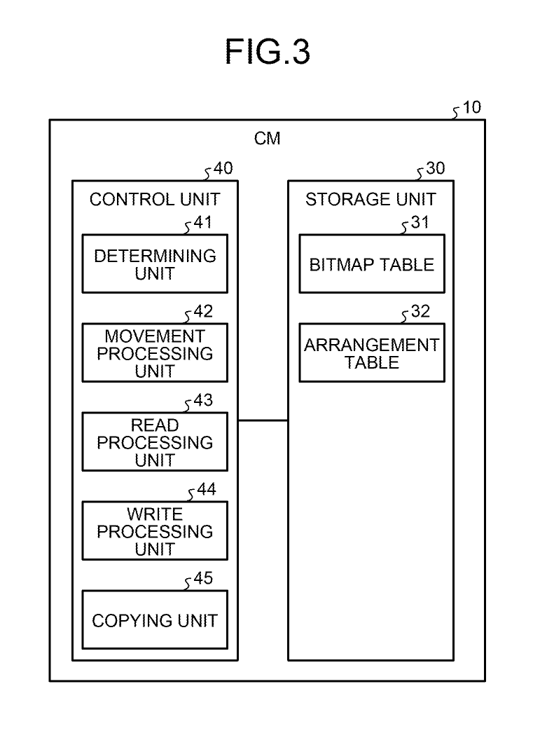

Next, a functional configuration of the CM 10 is explained. FIG. 3 illustrates a functional configuration of the CM 10. As illustrated in FIG. 3, the CM 10 includes a storage unit 30 and a control unit 40. The storage unit 30 stores data that are used by the control unit 40. The storage unit 30 is implemented by the cache memory 12 illustrated in FIG. 2.

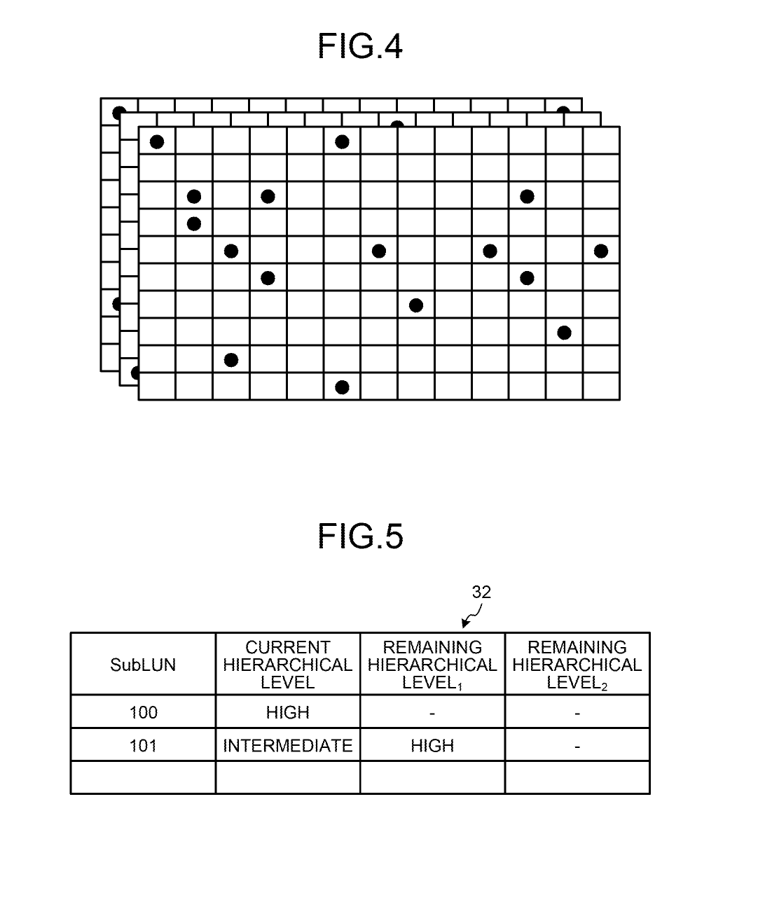

The storage unit 30 includes a bitmap table 31 and an arrangement table 32. The bitmap table 31 is a table indicating an updated area for each hierarchical level. FIG. 4 illustrates an image of the bitmap table 31.

FIG. 4 illustrates three pieces of bitmaps for the low hierarchical level, the intermediate hierarchical level, and the high hierarchical level. In each bitmap table, one bit is allocated for every 32 megabytes, and when a corresponding area of 32 megabytes is updated, “1” is set in the bit. In FIG. 4, a black circle indicates that “1” is set in the bit.

The arrangement table 32 indicates on which level data is stored for each sub-LUN. A logical unit number (LUN) is a number to identify each area in the storage, and a sub-LUN is a number to identify an area that is obtained by dividing the area identified by LUN into 1.34 gigabyte units. Data is moved among hierarchical levels in a unit of area identified by sub-LUN.

FIG. 5 illustrates an example of the arrangement table 32. In FIG. 5, current hierarchical level indicates on which level data of an area identified by sub-LUN is stored, remaining hierarchical level₁ and remaining hierarchical level₂ indicate on which level a copy thereof is stored.

For example, data of an area identified by sub-LUN “100” is currently stored only on the high hierarchical level 5, and data of an area identified by sub-LUN “101” is currently stored on the intermediate hierarchical level 4 and a copy thereof is stored on the high hierarchical level 5.

Moreover, the storage unit 30 stores an available storage amount, a disk usage rate, a disk busy rate, a response time, and the like of each hierarchical level.

Referring back to FIG. 3, the control unit 40 implements a control function of the CM 10, and includes a determining unit 41, a movement processing unit 42, a read processing unit 43, a write processing unit 44, and a copying unit 45. The control unit 40 is implemented by executing a program that is stored in the flash memory 14 by the CPU 13 illustrated in FIG. 2.

The determining unit 41 determines whether it is necessary to move data among hierarchical levels based on IOPS, and identifies sub-LUN for which the data is to be moved.

The movement processing unit 42 controls movement of data among hierarchical levels for sub-LUN that has been identified as an object of data movement by the determining unit 41. Specifically, the movement processing unit 42 determines whether a copy of the data is present at a destination of movement using the arrangement table 32, and when a copy of the data is not present, makes a copy of data on a destination hierarchical level from a source hierarchical level, and when a copy of the data is present, does not make a copy of the data.

Furthermore, the movement processing unit 42 determines whether 10% or more space is available on the source hierarchical level, and when determined that 10% or more space is available, controls to retain the data on the source hierarchical level, and when determined that 10% or more space is not available, initializes the area on the source hierarchical level.

The movement processing unit 42 controls to retain data on the source hierarchical level when 10% or more space is available on the source hierarchical level, and thus the initialization processing that becomes unnecessary if data is moved back and the movement processing to move back the data can be eliminated.

The read processing unit 43 reads data from a current hierarchical level on which the data is currently stored, to transmit to the server 1, based on a request from the server 1. However, when a copy of the data is stored on another hierarchical level, and a load on the current hierarchical level is high while a load on the other hierarchical level is not high, the read processing unit 43 reads the data from the other hierarchical level to transmit to the server 1.

The write processing unit 44 writes data on the current hierarchical level based on a request from the server 1. Moreover, when a copy of the data is stored on another hierarchical level, and a load on the current hierarchical level is high, the write processing unit 44 updates a part in the bitmap table 31 corresponding to the data, and does not make a copy of the data on the other hierarchical level. When a state in which a load on another hierarchical level is low continues for a predetermined time or longer, the write processing unit 44 makes a copy of the data on the other hierarchical level.

Furthermore, when a copy of the data is stored on another hierarchical level, and a load on the current hierarchical level is not high, the write processing unit 44 controls copy of the data to another hierarchical level based on a load and an available storage amount of the other hierarchical level.

The copying unit 45 performs copy of data from a source hierarchical level to a destination hierarchical level based on an instruction from the movement processing unit 42 and the write processing unit 44.

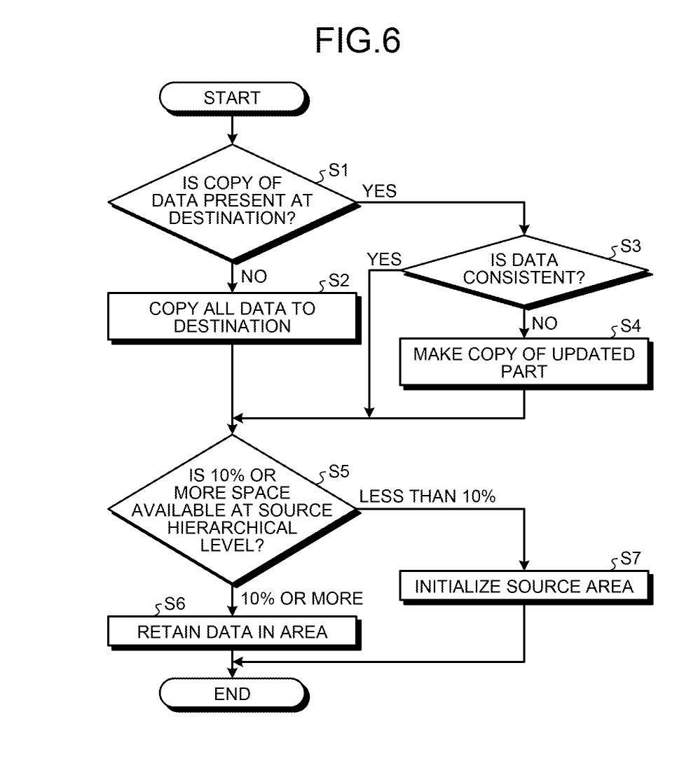

Next, a flow of hierarchy moving processing performed by the movement processing unit 42 is explained. FIG. 6 is a flowchart indicating the flow of the hierarchy moving processing performed by the movement processing unit 42. As indicated in FIG. 6, the movement processing unit 42 determines whether a copy of data is present at a moving destination (step S1). When determined that a copy of data is not present at the moving destination as a result, the movement processing unit 42 makes a copy of all the data at the moving destination using the copying unit 45 (step S2).

On the other hand, when a copy of data is present at the moving destination, the movement processing unit 42 determines whether the data is consistent between the moving destination and the source (step S3), and when determined consistent, proceeds to step S5 without making a copy of the data. On the other hand, when determined not consistent, the movement processing unit 42 makes a copy of an updated part based on a bitmap in the bitmap table 31 (step S4).

The movement processing unit 42 then determines whether the source hierarchical level has 10% or more available space (step S5), when 10% or more space is available, performs processing to retain data in the area (step S6), and when 10% or more space is not available, initializes the source area (step S7).

As described, the movement processing unit 42 controls to retain data in the source area when 10% or more space is available on the source hierarchical level, thereby omitting the processing of moving the data when the data is to be moved back.

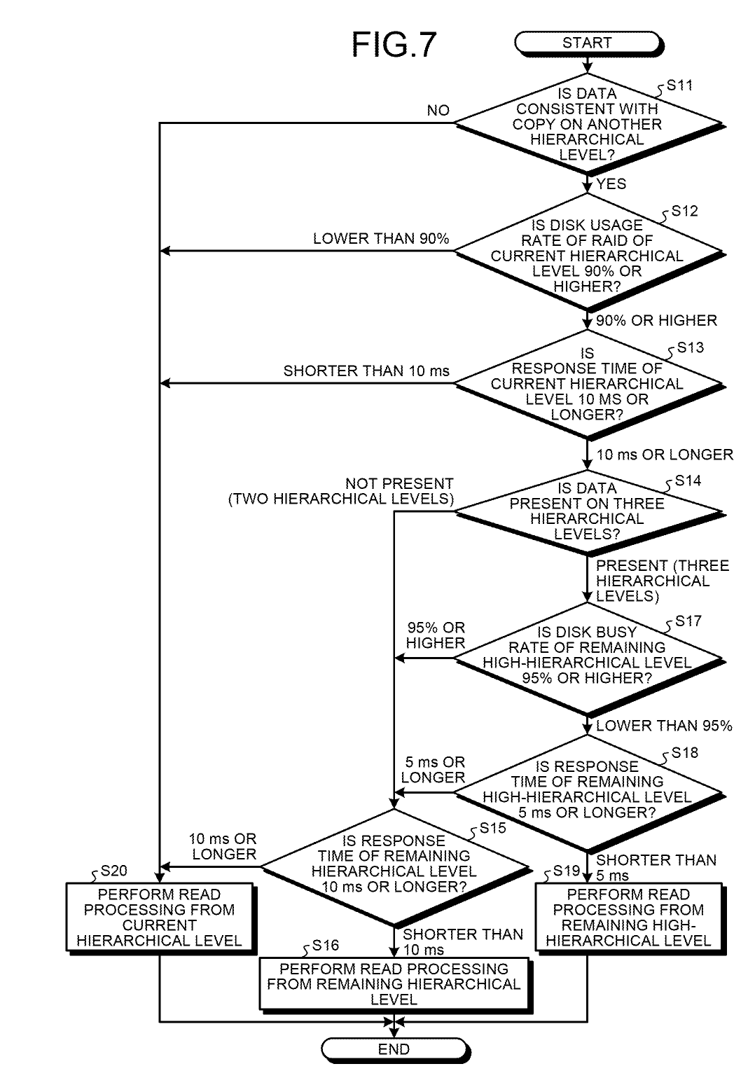

Next, a flow of a read processing performed by the read processing unit 43 is explained. FIG. 7 is a flowchart indicating a flow of the read processing performed by the read processing unit 43. As indicated in FIG. 7, the read processing unit 43 determines whether data is consistent with a copy on another hierarchical level (step S11), and when determined not consistent, performs the read processing from the current hierarchical level (step S20).

On the other hand, when determined consistent, the read processing unit 43 determines whether the disk usage rate of RAID on the current hierarchical level is 90% or higher (step S12), and when determined lower than 90%, performs the read processing from the current hierarchical level (step S20).

On the other hand, when determined 90% or higher, the read processing unit 43 determines whether the response time of the current hierarchical level is 10 milliseconds (ms) or longer (step S13), and when determined not 10 ms or longer, performs the read processing from the current hierarchical level (step S20).

On the other hand, when determined 10 ms or longer, the read processing unit 43 determines whether data is present on all of the three hierarchical levels (step S14). When determined, as a result, that data is not present on all of the three hierarchical levels, data is present on two hierarchical levels, and therefore, the read processing unit 43 determines whether the response time of a remaining hierarchical level that is a remaining one of the hierarchical levels is 10 ms or longer (step S15).

As a result, when determined 10 ms or longer, the read processing unit 43 performs the read processing from the current hierarchical level (step S20), and when determined not 10 ms or longer, performs the read processing from the remaining hierarchical level (step S16).

On the other hand, when the data is present on all of the three hierarchical levels, the read processing unit 43 determines whether a remaining high-hierarchical level that is higher in hierarchy than the current hierarchical level is present among the remaining hierarchical levels and the disk busy rate of the remaining high-hierarchical level is 95% or higher (step S17).

As a result, when determined that the disk busy rate of the remaining high-hierarchical level is 95% or higher, the read processing unit 43 proceeds to step S15, and checks the response time of a remaining hierarchical level other than the remaining high-hierarchical level. On the other hand, when determined that the disk busy rate of the remaining high-hierarchical level is not 95% or higher, the read processing unit 43 determines whether the response time of the remaining high-hierarchical level is 5 ms or longer (step S18).

As a result, when determined 5 ms or longer, the read processing unit 43 proceeds to step S15, and checks the response time of a remaining hierarchical level other than the remaining high-hierarchical level, and when determined not 5 ms or longer, performs the read processing from the remaining high-hierarchical level (step S19).

As described, the read processing unit 43 reads data from a hierarchical level having a low load when a copy of the data for which a read request is received is available, and therefore, the response performance of the system can be improved.

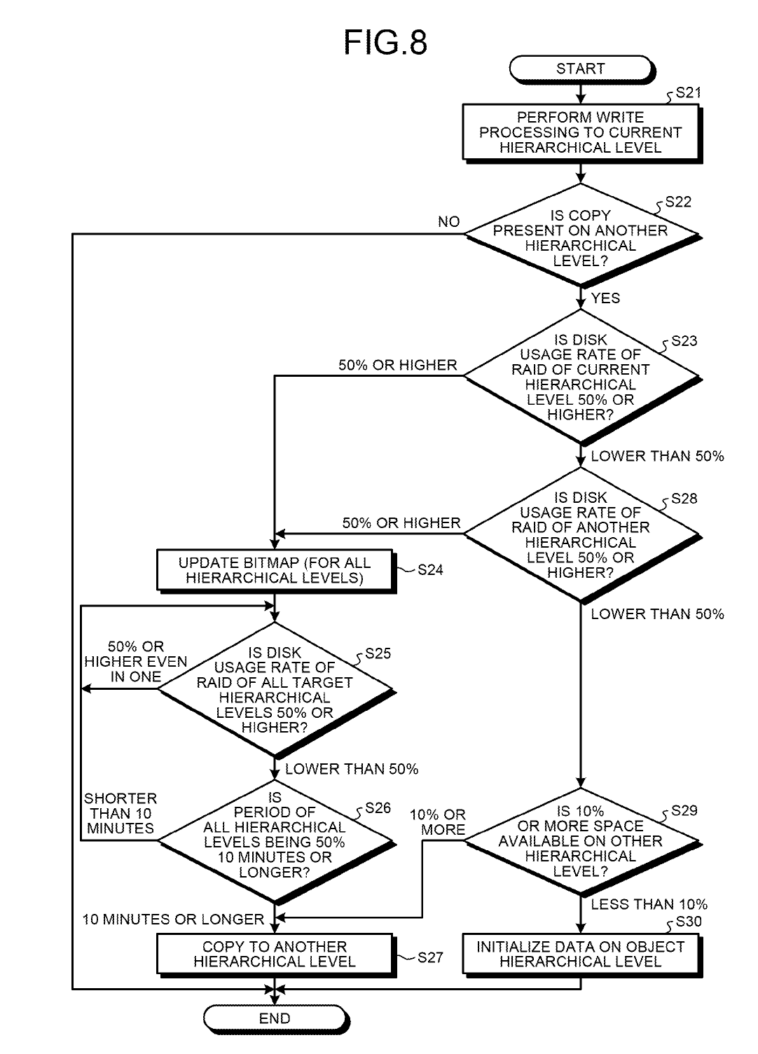

Next, a flow of write processing performed by the write processing unit 44 is explained. FIG. 8 is a flowchart indicating a flow of the write processing performed by the write processing unit 44. As indicated in FIG. 8, the write processing unit 44 performs the write processing to the current hierarchical level (step S21), and determines whether a copy of the data for which the write processing has been performed is present on another hierarchical level (step S22). As a result, when determined that a copy is not present on another hierarchical level, the write processing unit 44 ends the processing.

On the other hand, when a copy is present on another hierarchical level, the write processing unit 44 determines whether the disk usage rate of RAID of the current hierarchical level is 50% or higher (step S23). As a result, when determined 50% or higher, the write processing unit 44 updates a bitmap of a hierarchical level on which the copy is present in the bitmap table 31 (step S24).

Thereafter, the write processing unit 44 determines whether the disk usage rate of RAID is 50% or higher for all target hierarchical levels that require updates (step S25), and repeats the processing at step S25 when 50% or higher even in one.

On the other hand, when determined that the disk usage rates of RAID of all the target hierarchical levels that require updates are lower than 50%, the write processing unit 44 determines whether a period in which the disk usage rates of RAID of all the target hierarchical levels are lower than 50% is 10 minutes or longer (step S26).

As a result, when there is even one hierarchical level that the period in which the disk usage rate of RAID is lower than 50% is shorter than 10 minutes, the write processing unit 44 returns to step S25. On the other hand, when the period in which the disk usage rates of RAID of all the target hierarchical levels are lower than 50% is 10 minutes or longer, the write processing unit 44 makes a copy of the data to another hierarchical level using the copying unit 45 (step S27).

Moreover, when the disk usage rate of RAID of the current hierarchical level is not 50% or higher, the write processing unit 44 determines whether the disk usage rate of RAID of the another hierarchical level on which the copy is present is 50% or higher (step S28). As a result, for a hierarchical level determined as 50% or more, the write processing unit 44 proceeds to step S24 and updates a corresponding bitmap in the bitmap table 31.

On the other hand, for a hierarchical level determined lower than 50%, the write processing unit 44 determines whether 10% or more space is available on the other hierarchical level (that hierarchical level) (step S29), and when determined that 10% or more space is available, proceeds to step S27 to make a copy of the data to the other hierarchical level (step S27). On the other hand, when determined that 10% or more space is not available, the write processing unit 44 initializes the data on the target hierarchical level (step S30).

Thus, the write processing unit 44 updates copied data under the condition that a low-load state continues 10 minutes or longer, and therefore it is possible to maintain the consistency of data while reducing influence affecting the system performance.

As described above, in the embodiment, the movement processing unit 42 controls to retain data in a source area when 10% or more space is available at a source hierarchical level, and therefore, the movement processing and the initialization processing on the data can be eliminated when the data is to be moved back to the source. Accordingly, the CM 10 can suppress deterioration of the system performance when a return of data occurs among hierarchical levels by the automated storage tiering.

Furthermore, in the embodiment, when data for which a read request is received is present on more than one hierarchical level, the read processing unit 43 reads the data from a hierarchical level having a low load, and therefore, the response performance of the system can be improved.

Moreover, in the embodiment, when a load is high, the write processing unit 44 records an update state in the bitmap table 31 without updating a copy, and updates copied data under the condition that a low-load state continues 10 minutes or longer. Therefore, the write processing unit 44 can maintain the consistency of data while reducing influence affecting the system performance.

Furthermore, although in the embodiment, the automated storage tiering with three hierarchical levels has been explained, the present invention is not limited thereto, and is also applicable to automated storage tiering with more hierarchical levels similarly.

Moreover, although in the embodiment, the storage system having an SSD and HDDs has been explained, the present invention is not limited thereto, and is also applicable to a storage system having another type of drive device similarly.

According to one embodiment, deterioration of system performance that occurs under a certain condition by automated storage tiering can be suppressed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control apparatus that has an automated storage tiering function, comprising:
a determining unit that determines whether it is necessary to move data among hierarchical levels; and
a moving unit that controls copy of the data to a destination, and that controls retention of the data at a source based on an available space at the source, when the determining unit determines that it is necessary to move the data.

2. The storage control apparatus according to claim 1, wherein
the moving unit omits copy of the data when identical data to the data at the source is present at the destination.

3. The storage control apparatus according to claim 1, further comprising
a reading unit that controls, when the identical data is present on a plurality of hierarchical levels, read of data from a storage device based on input/output loads of the hierarchical levels.

4. The storage control apparatus according to claim 1, further comprising
a writing unit that controls, when the identical data is present on a plurality of hierarchical levels, write of data to another hierarchical level based on an input/output load of a current hierarchical level at time of writing the data to the current hierarchical level.

5. A control method of a storage control apparatus that has an automated storage tiering function, the control method comprising:
determining whether it is necessary to move data among hierarchical levels; and
controlling copy of the data to a destination, and controlling retention of the data at a source based on an available space at the source, when determined that it is necessary to move the data.

6. A computer-readable storage medium storing a program that is executed by a computer embedded in a storage control apparatus that has an automated storage tiering function, the program making the computer to execute a process comprising:
determining whether it is necessary to move data among hierarchical levels; and
controlling copy of the data to a destination, and controlling retention of the data at a source based on an available space at the source, when determined that it is necessary to move the data.
